(19) United States
(12) Patent Application Publication
(10) Pub. No.: US 2026/0028522 A1
(43) Pub. Date: Jan. 29, 2026

(54) WELLBORE FLUID ADDITIVES, WELLBORE FLUIDS COMPRISING SAID ADDITIVES, AND METHODS OF STRENGTHENING WELLBORES USING SAID FLUIDS

(71) Applicant: Schlumberger Technology Corporation, Sugar Land, TX (US)

(72) Inventors: Dimitri KHRAMOV, Houston, TX (US); Kristina DAEFFLER, Houston, TX (US); Christopher DAEFFLER, Sugar Land, TX (US)

(21) Appl. No.: 19/139,347

(22) PCT Filed: May 3, 2024
(86) PCT No.: PCT/US2024/027719

§ 371 Date: Jun. 15, 2025

Related U.S. Application Data
(60) Provisional application No. 63/500,426, filed on May 5, 2023.

(51) Int. Cl. C09K 8/508; C09K 8/516

(52) U.S. Cl. CPC C09K 8/5083; C09K 8/516

(57) ABSTRACT

Wellbore fluid additives, wellbore fluids comprising said additives, and methods of using said wellbore fluids reduce or prevent fluid losses and/or effectively seal wellbores during wellbore drilling operations. The wellbore fluid additives comprise at least one polymer-based fluid loss or wellbore sealant additive comprising swellable rubber-based elastomer particulates, swellable latex-based elastomer particles, or a combination thereof. The wellbore fluids comprise an aqueous base fluid, one or more weighting agents, and the at least one polymer-based fluid loss or wellbore sealant additive and has a density of at least about 9 ppg and no more than about 24 ppg.

### CROSS-REFERENCE TO RELATED APPLICATIONS

This application claims priority to and the benefit of U.S. Provisional Patent Application No. 63/500,426, filed on May 5, 2023, which is hereby incorporated by reference in its entirety.

### FIELD OF THE DISCLOSURE

The disclosure generally relates to wellbore fluid additives for strengthening and/or stabilizing one or more wellbore properties comprising elastomer-based particulates, wellbore fluids comprising said additives, and methods of using said fluids within subterranean formations to strengthen and/or stabilize one or more wellbore properties. The disclosure also relates to aqueous drilling fluids including aqueous base fluids and said additives comprising elastomer-based particulates.

### BACKGROUND

The statements in this section merely provide background information related to the present disclosure and do not constitute prior art.

It is known that prevention of fluid loss during wellbore drilling operations is a significant challenge in the oil and gas industries. Traditionally, wellbores are formed within or drilled into subterranean formations (earth formations; also referred to herein simply as “formations”) to recover hydrocarbons trapped within the subterranean formations. During wellbore drilling operations, wellbore fluids are typically circulated through the drill string, out the drill bit and upward in an annular passage provided between the drill string and the wall of the wellbore. Wellbore fluids are often used for, but not limited to: lubrication and cooling of drill bit cutting surfaces while drilling generally or drilling-in (i.e., drilling in a targeted petroliferous formation); transportation of “cuttings” (pieces of subterranean formation dislodged by the cutting action of the teeth on a drill bit) to the surface; controlling formation fluid pressure to prevent blowouts; maintaining well stability; suspending solids in the well; minimizing fluid loss into and stabilizing the subterranean formation through which the wellbore is being drilled; fracturing the subterranean formation in the vicinity of the wellbore; displacing the fluid within the wellbore with another fluid; cleaning the wellbore; testing the wellbore; transmitting hydraulic horsepower to the drill bit; fluid used for emplacing a packer; abandoning the wellbore or preparing the wellbore for abandonment; and treating the wellbore and/or formation.

Typically, some drilling fluids are lost into the subterranean formations (i.e., fluid loss) and not returned to the surface when the drilling fluids are used to lubricate the drill bits and/or carry rock cuttings to the surface. Fluid lost often results in a number of wellbore-related problems, such as, but not limited to, lost circulation, formation damage, and/or reduced wellbore stability. Lost circulation may occur when the drilling fluid is lost into the formation to the extent such that the remaining drilling fluid may no longer be able to carry cuttings to the surface. As a result of lost circulation, the drill bit may become stuck or lost in the formation which may further cause costly downtime and reduced drilling efficiency. Formation damage may occur when drilling fluids and other contaminants penetrate the formation being drilled and/or cause decreases in permeability and/or porosity of the formation. As a result of formation damage, the productivity of the well may be reduced and/or costly remediation efforts may be required to restore well performance. Damaged wellbore may be a problem because wellbore damage often leads to stuck and damaged tools, increased usage of drilling fluids and cement, and/or other known issues. Reduced wellbore stability may occur when fluid loss causes the formations to collapse or become unstable. As a result of reduced wellbore stability, one or more drilling tools may be lost, stuck pipe may occur, and/or the wellbores may collapse onto themselves.

Wellbore strength include the ability of a wellbore and/or borehole to resist failure due to loss of a circulating fluid, such as a drilling fluid. Fluid may be lost to the subterranean formation by encountering a so-called “thief zone” where the circulating fluid is lost in cavities defined by the earth formation. In addition, circulating fluid may be lost by permeating into cracks, pores, fractures, and fissures of the subterranean formation. Wellbore strengthening may be one effective fluid loss control strategy because loss of drilling fluids to formations through wellbore cracks often represents substantial losses of fluids and results in non-productive times during the wellbore drilling operations. Both of these factors incur additional costs to the service providers and/or operators. In aqueous drilling fluids, wellbore stabilizations take an additional meaning of reduction of fluid loss. Wellbore instabilities may be caused by pore pressure transmissions and reductions of pressure differentials near wellbores to zero which causes walls of the wellbores to often collapse. The issues of pore pressure transmissions and wellbore collapses may be more common with water-based fluids or muds than with synthetic-based fluids or muds and solutions to these issues are relevant and may be critical for maintaining or improving wellbore stabilities, maximizing drilling efficiencies, and/or optimizing well performances. Aqueous-based fluid may be desired due to reduced environmental impacts, reduced cost, and compatibility with formations.

Wellbore strengthening solutions exist; however, these known solutions are fluids with good wellbore strengthening characteristics but also exhibit undesirably high viscosities. As a result of such high viscosities, effective circulation densities of the wellbore fluids comprising these known solutions also cause damage to the wellbores.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

In one or more embodiments, a wellbore fluid is provided and may comprise an aqueous base fluid, one or more weighting agents, and at least one polymer-based fluid loss additive comprising swellable elastomer particulates, wherein wellbore fluid has a density of at least about 9 ppg and no more than about 24 ppg.

In an embodiment, the swellable elastomer particulates comprise solvent-swelled elastomer particulates.

In an embodiment, the swellable elastomer particulates comprise natural polymer particulates, synthetic polymer particulates, or a combination thereof.

In an embodiment, the swellable elastomer particulates comprise recycled rubber material and/or nitrile rubber material.

In an embodiment, the recycled rubber material is present in the wellbore fluid and in the form of grounded powder.

In an embodiment, the recycled rubber material is present in the wellbore fluid and comprises at least one synthetic rubber copolymer, carbon, at least one curing agent, and at least one fatty acid.

In an embodiment, the at least one synthetic rubber copolymer comprises styrene and butadiene, the carbon comprises carbon black, the at least one curing agent comprises zinc oxide, and/or the at least one fatty acid comprises stearic acid.

In an embodiment, the at least one polymer-based fluid loss additive is at least one latex-based fluid loss additive.

In an embodiment, the at least one latex-based fluid loss additive comprises at least one styrene-butadiene latex, at least one acrylic latex, at least on isoprene latex, at least one styrene vinyl pyrrolidone latex, at least one styrene-acrylic polymer, or a combination thereof.

In an embodiment, the at least one latex-based fluid loss additive comprises at least one styrene vinyl pyrrolidone latex.

In an embodiment, the density of the wellbore fluid is at least about 7 ppg and no more than about 15 ppg.

In one or more embodiments, a method is provided that may comprise introducing at least one polymer-based fluid loss additive into a mixture, comprising an aqueous base fluid and one or more weighting agents, to form a wellbore fluid, wherein the at least one polymer-based fluid loss additive comprises swellable elastomer particulates.

In an embodiment, the at least one polymer-based fluid loss additive is in the form of at least one latex, at least one dispersion, at least one powder, at least one slurry in at least one non-aqueous fluid, or a mixture thereof.

In an embodiment, the method further comprises swelling the swellable elastomer particulates with at least one solvent prior to or during introduction of the at least one polymer-based fluid additive into the mixture.

In an embodiment, the at least one solvent comprises at least one mutual solvent.

In an embodiment, the at least one polymer-based fluid loss additive comprises at least one latex-based fluid loss additive, at least one rubber-based fluid loss additive, or a combination thereof.

In an embodiment, the method further comprises circulating the wellbore fluid in a wellbore disposed within a subterranean formation, wherein the wellbore fluid has a density of greater than about 8.5 ppg.

In an embodiment, the at least one rubber-based fluid loss additive comprises recycled rubber material, nitrile rubber material, or a combination thereof, and/or the at least one latex-based fluid loss additive comprises at least one styrene-butadiene latex, at least one acrylic latex, at least on isoprene latex, at least one styrene vinyl pyrrolidone latex, or a combination thereof.

In one or more embodiments, a method of drilling a bore is provided and may comprise emplacing the wellbore fluid of claim 1 in a wellbore disposed within a subterranean formation and drilling the bore of the wellbore comprising the wellbore fluid.

In an embodiment, the polymer-based fluid loss additive comprises at least one rubber-based fluid loss additive comprising recycled rubber material, nitrile rubber material, or a combination thereof, at least one latex-based fluid loss additive comprising at least one styrene-butadiene latex, at least one acrylic latex, at least on isoprene latex, at least one styrene vinyl pyrrolidone latex, or a combination thereof, or a combination thereof.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a chart illustrating fluid loss when testing the formulation set forth in Table 1, wherein fluid loss was tested at 200° F. or 280° F. on a synthetic disk designed to simulate formation rock for all products except styrene vinyl pyrrolidone, which was tested at 200° F. on paper, and further wherein all percent reduction values are compared to a base with no additive that was treated and tested similarly and testing was done with 500 psi differential pressure and conducted for 30 minutes.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” As used herein, the phrases “selected from the group consisting of,” “chosen from,” and the like include mixtures of the specified compounds and/or materials. Terms, such as, for example, “contains” and the like are meant to include “including at least” unless otherwise specifically noted.

Herein, the term “about” when applied to a value generally means within the tolerance range of the equipment used to produce the value, or in some examples, means plus or minus 20%, plus or minus 15%, plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Where a numerical limit or range is stated, the endpoints are included. Also, all values and subranges within a numerical limit or range are specifically included as if explicitly written out. Moreover, examples herein are intended to be illustrative only and are presented for discussion purposes and not by way of limitation.

### Wellbore Fluid Additives

Embodiments disclosed herein relate to wellbore fluid additives for strengthening one or more wellbore properties comprising one or more elastomers and/or elastomer-based particulates (collectively referred to hereinafter as “the elastomer” and/or “the particulates”), wherein the wellbore fluid additives are, comprise, and/or consist of one or more fluid loss additives, one or more wellbore sealants, or a combination thereof (collectively referred to hereinafter as “the fluid loss additive” and/or “the wellbore sealants”). In other words, the elastomers and/or elastomer-based particulates may comprise fluid loss additives and/or wellbore sealants. Additional embodiments disclosed herein relate to wellbore fluids comprising the elastomer, the particulates, the fluid loss additive, the wellbore sealants, or a combination thereof. Further embodiments disclosed herein relate to methods of forming and/or using the wellbore fluids within subterranean formations to strengthen one or more wellbore properties. Still further embodiments relate to aqueous drilling fluids including one or more aqueous base fluids comprising the elastomer, the particulates, the fluid loss additive, and/or the wellbore sealants and/or methods of forming the aqueous drilling fluids and/or drilling one or more wellbores with the aqueous drilling fluids. In some embodiments, the wellbore fluid additives include each of the elastomer, the particulates, the fluid loss additives, and the sealant. The wellbore fluid additives may be polymer based and may be referred to herein as “polymer-based fluid loss additives.”

In contrast to known wellbore strengthening solutions, the wellbore fluid additives, wellbore fluids comprising said wellbore fluid additives, and methods of using said wellbore fluids disclosed herein prevent, reduce, or restrict one or more fluid losses during one or more wellbore drilling operations and one or more problems associated with fluid losses (i.e., lost circulation, formation damage, reduced wellbore stability, etc.) and/or address and overcome one or more issues associated with wellbore instabilities, pore pressure transmissions, and/or wellbore collapses.

In some embodiments, the wellbore fluid additive(s) disclosed herein may be, comprise, or consist of one or more fluid loss additives that control, prevent, and/or reduce fluid loss and/or effectively seal the wellbore during wellbore drilling operations. The one or more fluid loss additives may reduce the amounts of drilling fluids lost into the formations being drilled (e.g., by lowering the volume of filtrate that passes through the formation), improve drilling efficiencies, and/or maintain wellbore stabilities. The one or more fluid loss additives may create at least one filter cake on at least one borehole wall of the wellbore which may block fluid loss into the formation associated with the wellbore. The filter cake is formed by the deposition of solid particles and/or polymers from the one or more fluid loss additives and/or the drilling fluid onto the borehole wall such that the particles and/or polymers seal pores and/or fractures in the formation and reduce or prevent the flow of drilling fluid into the formation. In at least one embodiment, the one or more fluid loss additives added to the drilling fluid may improve the rheology and/or density of the drilling fluid in addition to reducing fluid loss of the drilling fluid. As a result, the one or more fluid loss additives may control fluid loss in wellbore drilling operations and/or be usable in a plurality of drilling applications (i.e., onshore and offshore drilling) for maintaining wellbore stability and optimizing drilling efficiency.

In one or more embodiments, the wellbore fluid additive(s) may be, comprise, or consist of one or more wellbore sealants comprising one or more materials that seal and/or isolate one or more sections of the wellbore. The one or more wellbore sealants disclosed herein may reduce or prevent unwanted fluids, such as water, gas, or oil, from migrating between different zones and/or formations in the wellbore and/or between bores of the wellbores and the formations. As a result, the one or more wellbore sealants may maintain well integrity of the wellbores, prevent leaks from forming in the formations and/or wellbores, and/or optimize production with respect to (e.g., from) the wellbores and/or formations.

In an embodiment, the one or more wellbore sealants may be, comprise, or consist of at least one polymer-based sealant, at least one elastomer-based sealant, at least one resin-based sealant, at least one latex-based sealant, or a combination thereof. The one or more wellbore sealants may be made, provided, or produced by mixing two or more reactive chemicals to form at least one solid and/or impermeable or semi-impermeable material that may provide a rapid-setting and/or flexible seal. In at least one embodiment, the one or more wellbore sealants may be based on one or more specific requirements of the wellbores and/or the drilling operations or one or more additional factors, such as, for example, temperatures, pressures, fluid types, and/or geometries associated with the wellbores, the formations, and/or the drilling operations. Moreover, wellbore sealing operations utilizing the one or more wellbore sealants disclosed herein may maintain well integrity and well stability, avoid costly remedial work, and/or ensure safe and efficient production.

In some embodiments, the elastomer and/or the particulates disclosed herein may be added to, delivered to, incorporated into, mixed into, and/or introduced into the wellbore fluids and/or aqueous drilling fluids in the form(s) of at least one latex (an emulsion of polymer microparticles in a fluid (e.g., water)), at least one dispersion, at least one powder, at least one slurry in at least one non-aqueous fluid, or a combination thereof. Further, the fluid loss additive and/or the wellbore sealant may be added to, delivered to, incorporated into, mixed into, and/or introduced into the wellbore fluids and/or aqueous drilling fluids at the surface, at a location downhole, within the wellbore, within a circulation path associated with the wellbore, or a combination thereof. In one or more embodiments, improvements to wellbore sealing and fluid loss prevention may be achieved by combining the elastomer and/or the particulates with at least one solvent which causes swelling and/or softening of the elastomer and/or the particulates. In some embodiments, the at least one solvent may be, comprise, or consist of at least one mutual solvent (e.g., a solvent or additive that is soluble in one or more of (e.g., each of) oil, water, and acid-based treatment fluids), at least one chemical additive that is soluble in oil, water, one or more alcohols, one or more organic solvents, one or more acid-based fluids, or a combination thereof. In some embodiments, the at least one solvent is soluble in an aqueous base fluid. In other embodiments, the at least one solvent is soluble in an oil-based fluid. In some embodiments, the wellbore fluid includes a water-based fluid and the at least one solvent is soluble in a hydrocarbon phase of an emulsion of the water-based fluid. In an embodiment, the at least one solvent may be, comprise, or consist of at least one alkyl ethoxylate, such as, for example, ethyleneglycolmonobutyl ether (hereinafter “EGMBE”). In some embodiments, the at least one solvent includes a glycol (e.g., polyethylene glycol (PEG)). In one or more embodiments, the at least one solvent may be, comprise, or consist of at least one chlorinated solvent, at least one alkyl ethoxylate, at least one aromatic, at least one aromatic-containing fluid, at least one vegetable oil, at least one ester, or a combination thereof. In at least one embodiment, the at least one chlorinated solvent may be chlororform, methylene chloride, perchloroethylene, or a combination thereof, the at least one aromatic may be toluene, xylene, a similar aromatic, or a combination thereof, and/or the at least one aromatic-containing fluid may be a diesel. In some embodiments, the at least one solvent is an aromatic material. Moreover, the fluid loss additive and/or the wellbore sealant may provide and/or achieve improvements to the integrity of the cuttings within the wellbores.

In at least one embodiment, the one or more wellbore fluid additives disclosed herein may be, comprise, or consist of one or more wax dispersions, one or more emulsions of liquid polymers, one or more latexes, one or more solid elastomers, one or more silicone oil emulsions, one or more nano-scale solids, or a combination thereof. Such materials may be present in the wellbore fluid as elastomeric particulates and may be swellable. In at least one embodiment, the one or more latexes may be, comprise, or consist of one or more styrene-butadiene latexes, one or more acrylic latexes, one or more isoprene latexes, one or more styrene-vinyl pyrrolidone latexes, one or more nitrile butadiene latexes, one or more partially- or fully-carboxylated styrene-butadiene polymers, one or more styrene-butadiene polymers, one or more styrene-acrylic polymers, or a combination thereof. In at least one embodiment, the one or more isoprene latexes may be, comprise, or consist of at least one copolymer of isoprene and styrene. In some embodiments, the one or more wellbore fluid additives disclosed herein may be, comprise, or consist of one or more elastomeric additives comprising one or more rubber-like and/or rubber-based materials. In more than one embodiment, the one or more elastomeric additives may be, comprise, or consist of one or more grounded and/or recycled rubber materials. The one or more elastomeric additives may be present in the wellbore fluid in the form of grounded powder. The one or more elastomeric additives may also be referred to herein as elastomer particulates and may include swellable elastomer particulates. In some embodiments, the swellable elastomer particulates may include solvent-swelled elastomer particulates. In some embodiments, the swellable elastomer particulates include natural polymer particulates, synthetic polymer particulates, or a combination thereof. In an embodiment, the one or more grounded and/or recycled rubber materials may be, comprise, or consist of at least one grounded tire rubber material, at least one nitrile butadiene rubber material (also referred to as “nitrile rubber material”), or a combination thereof. In one or more embodiments, the one or more latexes and/or the one or more solid elastomers may be present in the wellbore fluids at a concentration of no more than about 10 vol %, no more than about 5 vol %, or no more than about 3 vol %. In some embodiments, the one or more latexes and/or the one or more solid elastomers may individually be present in the wellbore fluids at a concentration within a range of from about 1.0 vol % to about 10.0 vol %, such as from about 1.0 vol % to about 2.0 vol %, from about 2.0 vol % to about 3.0 vol %, from about 3.0 vol % to about 5.0 vol %, from about 5.0 vol % to about 7.0 vol %, or from about 7.0 vol % to about 10.0 vol %.

One or more wellbore fluid additives disclosed herein improve fluid-rock interactions between drilling fluids comprising said wellbore fluid additives and rock surfaces of formations associated with the wellbores. To prevent wellbore collapses due to fluid-wellbore interactions, drilling fluids comprising the one or more wellbore fluid additives disclosed herein may eliminate fluid-rock interaction or at least substantially reduce the fluid-rock interaction. This benefit (i.e., elimination or reduction of fluid-rock interaction) when reduced to practice may also mean or equate to reduction of fluid loss in a laboratory test. Fluid loss reduction in aqueous-based or water-based drilling fluids or muds (collectively referred to hereinafter as “WBM”) may be achieved with one or more polymer-based drilling fluid additives. In one or more embodiments, the one or more polymer-based drilling fluid additives may be, comprise, or consist of one or more natural polymers, one or more synthetic polymers, one or more water-soluble polymers, or a combination thereof. In some embodiments, the one or more polymer-based drilling fluid additives are different than the wellbore fluid additives including the elastomer and/or the elastomer-based particulates.

In some embodiments, the one or more polymer-based drilling fluid additives may be, comprise, or consist of one or more polyanionic celluloses, one or more starches, one or more latexes, xanthan, or a combination thereof. In one or more embodiments, the one or more polymer-based drilling fluid additives may be, comprise, or consist of at least one water-soluble polymer that may be derived from cellulose, at least one natural polymer comprising a plurality of glucose units that may be linked together by one or more glycosidic bonds, at least one synthetic polymer that may be made by emulsion polymerization, or a combination thereof. In an embodiment, the one or more polymer-based drilling fluid additives may be, comprise, or consist of one or more large molecule polymers made up of repeating units, or monomers, that may be chemically bonded together. In one example, the repeating units, may be glucose, styrene, butadiene, or a combination thereof. In one or more embodiments, the one or more polymer-based drilling fluid additives disclosed herein may control viscosity and filtration properties of the drilling fluids, and/or may be, comprise, or consist of a fluid-loss control agent and/or a wellbore sealant to prevent the loss of drilling fluids into the formations and/or effectively seal the wellbore.

In some embodiments, the one or more polymer-based drilling fluid additives may be, comprise, or consist of the elastomers (i.e., synthetic and/or natural polymers) that may reduce fluid losses without contributing to viscosities of the drilling fluids comprising said elastomers. The elastomers may include one or more of the materials described above, such as one or more of the elastomeric additives, one or more of the sealants, and/or one or more latexes. Further, materials of the synthetic and/or natural polymers may be softened with the one or more solvents such that the softened materials have improved performance with respect to preventing or reducing fluid loss which may be applied to existing latexes or can be combined with one or more other additives (e.g., wellbore fluid additives) to tune or control the performance of the fluid loss additive disclosed herein. In one embodiment, the wellbore fluid additives disclosed herein may be, comprise, or consist of one or more amine inhibitors and/or one or more encapsulators which may improve or maintain cuttings integrity but may not improve or maintain wellbore stabilization. For example, in addition to the elastomers, particulates, fluid loss additives, and sealants described above, the wellbore fluid additives may further include one or more amine inhibitors and/or one or more encapsulators.

As described above, the wellbore fluid additives (e.g., the polymer-based wellbore fluid additives, the polymer-based drilling fluid additives) may exhibit a softness and pliability sufficient to reduce and/or substantially prevent (e.g., prevent) fluid loss of the wellbore fluid into the formation. The wellbore fluid additives may exhibit a shore durometer less than about 90 Shore A, less than about 80 Shore A, less than about 70 Shore A, less than about 60 Shore A, less than about 50 Shore A, less than about 40 Shore A, less than about 30 Shore A, less than about 25 Shore A, less than about 20 Shore A, less than about 15 Shore A, or less than about 10 Shore A. Without being bound by any particular theory, it is believed that the reduced hardness of the wellbore fluid additives facilitates emplacement of the wellbore fluid additives in cracks, pores, fissures, or other openings in the formation, reducing the amount of wellbore fluids that may enter and infiltrate the formation. Accordingly, wellbore fluid additives exhibiting a desired softness may reduce an amount of wellbore fluids loss in the formation.

A size of the wellbore fluid additives may be within a range of from about 10 nm to about 1.0 mm, such as from about 10 nm to about 50 nm, from about 50 nm to about 100 nm, from about 100 nm to about 200 nm, from about 200 nm to about 400 nm, from about 400 nm to about 700 nm, from about 700 nm to about 1.0 μm, from about 1.0 μm to about 5.0 μm, from about 5.0 μm to about 10.0 μm, from about 10.0 μm to about 50.0 μm, from about 50.0 μm to about 100 μm, from about 100 μm to about 200 μm, from about 200 μm to about 500 μm, or from about 500 μm to about 1.0 mm. In some embodiments, an average size of the wellbore fluid additives is within a range of from about 100 nm to about 200 nm.

In one or more embodiments, the one or more polymer-based drilling fluid additives disclosed herein may be, comprise, or consist of at least one recycled rubber material, at least one synthetic rubber, or a combination thereof. In some embodiments, the at least one recycled rubber material may be, comprise, or consist of Lehigh rubber which is a type of recycled rubber material produced by Lehigh Technologies in the United States. The at least one recycled rubber material may be, comprise, or consist of scrap tire rubber that has been finely ground into a powder and then processed to remove any impurities. The at least one recycled rubber material may cost-effective, as it is made from recycled materials, and may require less energy to produce. Further, the at least one recycled rubber material may be sustainable, as it reduces the amount of waste generated by the tire industry, and may help to reduce the demand for virgin rubber. In one or more embodiments, the at least one synthetic rubber may be, comprise, or consist of styrene butadiene rubber and/or the at least one recycled rubber material and/or the at least one synthetic rubber may be premixed with one or more swelling solvents.

In some embodiments, the one or more polymer-based drilling fluid additives disclosed herein may be, comprise, or consist of at least one recycled rubber material produced by grinding scrap tire rubber into a fine powder and subsequently removing any, all, or at least some impurities. The chemical makeup of the at least one recycled rubber material may vary depending on the source of the scrap tire rubber and/or the specific processing methods used by the manufacturer. In general, the at least one recycled rubber material may be, comprise, or consist of at least one synthetic rubber copolymer, carbon (e.g., carbon black), at least one curing agent (e.g., zinc oxide, magnesium oxide, lead oxide), at least one fatty acid (e.g., stearic acid), one or more optional additives, or a combination thereof. In an embodiment, the at least one recycled rubber material may be, comprise, or consist of a copolymer of styrene and butadiene, carbon black, zinc oxide, stearic acid, the one or more optional additives, or a combination thereof. Additionally, the one or more optional additives may be, comprise, or consist of one or more antioxidants, one or more accelerators, one or more crosslinkers, one or more plasticizers, or a combination thereof.

The one or more wellbore fluid additives may be present in the wellbore fluid at a concentration within a range of from about 1.0 vol % to about 10.0 vol %, such as from about 1.0 vol % to about 2.0 vol %, from about 2.0 vol % to about 3.0 vol %, from about 3.0 vol % to about 5.0 vol %, from about 5.0 vol % to about 7.0 vol %, or from about 7.0 vol % to about 10.0 vol %.

### Optional Fluid Additives

Optional wellbore fluid additives (in addition to the wellbore fluid additives described above) may be added to, incorporated into, mixed into, or included in the wellbore fluids disclosed herein. The optional wellbore fluid additives may include one or more rheological additives, one or more polymeric shale inhibitor additives, or at least one mixture thereof. For example, the one or more rheological additives may comprise one or more viscosifying agents, and the one or more polymeric shale inhibitor additives may comprise one or more encapsulating polymer agents. Other known wellbore fluid additives may be incorporated into the wellbore fluids disclosed herein as known to one of ordinary skill in the art.

The one or more viscosifying agents may alter or maintain the viscosity and potential changes in viscosity of the wellbore fluid. Viscosity control may be needed or desired in some scenarios in which a subterranean formation contains varying temperature zones. For example, the wellbore fluid may undergo temperature extremes of nearly freezing temperatures to nearly the boiling temperature of water or higher as the wellbore fluid moves from the surface to the drill bit and back to the surface.

In one or more embodiments, the one or more viscosifying agents may be selected from one or more natural biopolymers that are usable in WBM. In embodiments, the one or more natural biopolymers may include starches, celluloses (e.g., carboxymethylcellulose sodium salt), and/or various gums, such as xanthan gum, diutan gum, gellan gum, welan gum, scleroglucan gum and/or at least one or more mixtures thereof. Said starches may include potato starch, corn starch, tapioca starch, wheat starch, rice starch, and/or at least one mixture thereof. In some embodiments, the one or more viscosifying agents may comprise at least one gum, such as, for, example, xanthan gum, diutan gum, or mixtures thereof. In accordance with various embodiments of the present disclosure, the one or more biopolymer viscosifying agents may be unmodified (i.e., without derivitization). In embodiments, the one or more viscosifying agents may include, for example, at least one of POLYPAC® UL polyanionic cellulose (PAC), DUOVIS®, and BIOVIS®, each available from M-I L.L.C. (Houston, Tex.).

In some embodiments, the one or more viscosifying agents may be one or more polymeric viscosifiers comprising synthetic polymers that resist degradation over time, and/or under high temperature/high pressure conditions (e.g., thermal and pressure stable polymeric viscosifiers). Thermal and pressure stable polymeric viscosifiers polymers may include polymers, copolymers, block copolymers, and higher order copolymers (i.e., a terpolymer or quaternary polymer, etc.) composed of monomers that may include 2-acrylamido-2-methylpropanesulfonate, acrylamide, methacrylamide, N,N dimethyl acrylamide, N,N dimethyl methacrylamide, tetrafluoroethylene, dimethylaminopropyl methacrylamide, N-vinyl-2-pyrrolidone, N-vinyl-3-methyl-2-pyrrolidone, N-vinyl-4,4-diethyl-2-pyrrolidone, 5-isobutyl-2-pyrrolidone, N-vinyl-3-methyl-2-pyrrolidone, alkyl oxazoline, poly(2-ethyl-2-oxazoline), C2-C12 olefins, ethylene, propylene, butene, butadiene, vinyl aromatics, styrene, alkylstyrene, acrylic acid, methacrylic acid, vinyl alcohol, partially hydrolyzed acrylamide or methacrylamide, derivatives thereof, and/or mixtures thereof. In yet other embodiments, polymeric viscosifiers may include polyalkylene amines and polyethers, such as, for example, polyethylene oxides, polypropylene oxide, and/or mixtures thereof.

In one or more embodiments, the polymeric viscosifiers may include, for example, thermally stable polymeric viscosifiers, such as, for example, DUROTHERM™, DURALON™, available from MI, L.L.C. (Houston, Tex.), KEMSEAL™, available from Baker Hughes, Inc. (Houston, Tex.), DRISCAL®-D, available from Phillips Petroleum Co. (Bartlesville, Olka), CYPAN™, available from National Oilwell Varco (Houston, Tex.), and ALCOMER™ 242, available from Allied Colloids Ltd (United Kingdom). In other embodiments, the one or more viscosifying agents may be, for example, IDCAP™ D, available from MI L.L.C. (Houston, Tex.).

In embodiments, the one or more viscosifying agents may comprise additional components comprising at least one organic compound. The additional components may be compounds comprising at least one aldehyde group or two aldehyde groups. For example, the at least one organic compound may be a dialdehyde, such as, for example, glyoxal.

The wellbore fluids disclosed herein may contain one or more viscosifying agents in an amount of about 0.5 to about 5 pounds per barrel (hereinafter “ppb”), about 0.25 to about 2 ppb, or up to about 4 ppb. However, the concentration ranges may be dependent upon, for example, particular wellbore diameters, annular velocities, cutting carrying capacities, and/or quiescent times expected or desired. The one or more viscosifying agents may have, but are not limited to, viscosities of about 1.2 to about 1.8 Pa*s or about 1.1 to about 1.9 Pa*s and a specific gravity of about 1.2 to about 1.8, about 1.4 to about 1.6, or about 1.5. In some embodiments, the amount of the one or more viscosifying agents may be less than about 0.5 ppb or greater than about 5 ppb and/or the viscosity may be less than about 1.2 Pa*s or greater than about 1.9 Pa*s.

In one or more embodiments, the wellbore fluids disclosed herein may comprise one or more encapsulating polymer agents that may form a viscous polymer coating, film, or barrier on, for example, cuttings and walls of the wellbores. The viscous polymer coating, film, or barrier may seal microfractures of the wellbores and/or formations. In embodiments, the one or more encapsulating polymer agents may comprise at least one of one or more partially-hydrolyzed polyacrylamides, one or more acrylate polymers, one or more acrylate copolymers, and mixtures thereof. In an embodiment, the one or more encapsulating polymer agents may be acrylic acid copolymer encapsulators. The one or more encapsulating polymer agents may be present in the wellbore fluids at concentrations of about 1 kg/m³ to about 12 kg/m³, or no more than about 3 or about 4 vol. %, calculated to total volumes of the wellbore fluids. In embodiments, the one or more encapsulating polymer agents may have specific gravities of about 1.2 to about 1.8 or about 1.4 to about 1.6.

Moreover, the wellbore fluids disclosed herein may include weighting materials or weighting agents to increase the densities of the wellbore fluids. The weighting materials or agents may increase the densities of the wellbore fluids so as to reduce or prevent kick-backs and blow-outs. Thus, the weighting materials or agents may be added to the wellbore fluids in functionally effective amounts largely dependent on the nature of the subterranean formations being drilled. Weighting agents or density materials usable in the wellbore fluids disclosed herein include galena, hematite, magnetite, iron oxides, ilmenite, barite, siderite, celestite, dolomite, calcite, and the like, mixtures and combinations of these compounds and similar such weighting materials that may be used in the formulations of the wellbore fluids. The quantity of such material added, if any, may depend upon the desired density of the final compositions of the wellbore fluids. In some instances, weighting agent is added to result in a drilling fluid density of at least about 9 and/or up to about 24 pounds per gallon (ppg). The weighting agent may be added up to 21 ppg in some embodiments, and up to 19.5 ppg in other embodiments. In one or more embodiments, the density of the drilling fluids disclosed herein may be at least about 9 ppg, at least about 11 ppg, or at least about 13 ppg.

The density of the wellbore fluid may be at least about 9 ppg and up to about 24 ppg. In some embodiments, the wellbore fluid has a density greater than about 8.5 ppg. In some embodiments, the density of the wellbore fluid is within a range of from about 9 ppg to about 24 ppg, such as from about 9 ppg to about 14 ppg, from about 14 ppg to about 19 ppg, or from about 19 ppg to about 24 ppg. In some embodiments, the density of the wellbore fluid is at least about 7 ppg (or at least about 10 ppg) and no more than about 15 ppg.

In some embodiments, the other wellbore fluid additives may also include, for example, one or more thinners and/or one or more fluid loss control agents which may be optionally added to wellbore fluids disclosed herein. Of these additional materials, each may be added to the formulation in a concentration as rheologically and functionally required by wellbore drilling conditions and/or operations.

### Wellbore Fluids

Wellbore fluids disclosed herein may contain a base fluid that is entirely aqueous base (an aqueous base fluid) or contains a full or partial oil-in-water emulsion. In some embodiments, the wellbore fluid may be any aqueous-based or water-based fluid that is compatible with the wellbore fluid additives, the fluid loss additives, the wellbore sealants, the elastomers, and/or the particulates disclosed herein. In some embodiments, the base fluid may include at least one of fresh water or mixtures of water-soluble organic compounds and water.

In one or more embodiments, the wellbore fluids may contain a brine such as seawater, aqueous base fluids, or solutions wherein the salt concentration is less than that of sea water, or aqueous fluids or solutions wherein the salt concentration is greater than that of sea water. Salts that may be found in seawater include, but are not limited to, sodium, calcium, aluminum, magnesium, potassium, strontium, lithium, and salts of chlorides, bromides, carbonates, iodides, chlorates, bromates, formates, nitrates, oxides, sulfates, phosphates, silicates and fluorides. Salts that may be incorporated into given brines include any one or more of those present in natural seawater or any other organic or inorganic dissolved salts. Additionally, brines that may be used in the wellbore fluids disclosed herein may be natural or synthetic, with synthetic brines tending to be much simpler in constitution. One of ordinary skill would appreciate that the above salts may be present in the base fluids or may be added according to the methods disclosed herein. Further, the amount of the aqueous based continuous phase should be sufficient to form the WBM. This amount may range from nearly 100% of the wellbore fluids to less than about 30% of the wellbore fluids by volume. In some embodiments, the aqueous-based continuous phase may constitute from about 98% by volume to about 25% by volume, from about 95% by volume to about 30% by volume, or from about 90% by volume to about 40% by volume of the wellbore fluids.

In some embodiments, the wellbore fluids disclosed herein may be high performance WBMs comprising wellbore fluid additives disclosed herein for reducing or preventing fluid loss with respect to the wellbore or formation and/or for sealing one or more surfaces of the wellbore or formation. Prevention of fluid loss may be important to WBM performance because wellbore integrity depends on fluid loss properties of WBM. Additionally, prevention and/or reduction in fluid loss reduces costs associated with the wellbore drilling operations or processes by reducing the volumes of dilution needed to maintain acceptable viscosities for the WBMs. In embodiments, the high performance WBMs disclosed herein may comprise at least the aqueous base fluid, the wellbore fluid additives disclosed herein (e.g., one or more of (e.g., each of) the elastomers, the elastomer-based particulates, the sealants, the fluid loss additives, the polymer-based drilling fluid additives), one or more viscosifying agents, and one or more encapsulating polymer agents, or a mixture thereof. The wellbore fluids disclosed herein may have pH values of less than about 11.5, about 8.5 to about 11, about 9.0 to about 10.5, about 9.5 to about 10.5, greater than about 10, or greater than about 11.

In yet another embodiment, the wellbore fluids disclosed herein may be used alone or in combination with one or more optional, conventional, or additional additives (collectively referred to hereinafter as “the additional additives”). The additional additives, that may further be included in the present wellbore fluids, may include, for example, wetting agents, organophilic clays, additional viscosifiers, fluid loss control agents, surfactants, dispersants, interfacial tension reducers, pH buffers, mutual solvents, additional thinners, additional thinning agents, cleaning agents, or mixtures thereof. Inclusion of the additional additives in the present wellbore fluids should be well known to one of ordinary skill in the art of formulating wellbore fluids, WBMs, aqueous-based drilling fluids, or a combination thereof.

### Methods For Producing/Using Wellbore Fluids

In one or more embodiments, the methods disclosed herein may include providing, formulating, and/or mixing a wellbore fluid (e.g., a drilling fluid, reservoir drill-in fluid, fracturing fluid, etc.) that contains or comprises the aqueous base fluid, weighting agents, and/or the inventive wellbore fluid additives disclosed herein. In some embodiments, the methods disclosed herein may emplace, dispose, and/or provide the wellbore fluids within wellbores of subterranean formations. The above-mentioned wellbore fluid additives may be mixed into the wellbore fluid individually or as a multi-component additive that contains the present wellbore fluid additives disclosed herein, one or more viscosifying agents, one or more encapsulating agents, one or more weighting agents, and/or one or more additional additives. The above-mentioned wellbore fluid additives and/or the additional additives may be added to the wellbore fluids prior to, during, or subsequent to emplacing or circulating the wellbore fluids in the subterranean formations.

The wellbore fluids disclosed herein comprising the wellbore fluid additives disclosed herein may be used in methods or operations for drilling wellbores into the subterranean formations in a manner similar to those wherein conventional wellbore fluids are used. In the methods of drilling, the wellbore fluid disclosed herein may be circulated through the drill pipe, through the bit, and up the annular space between the pipe and the formation or steel casing to the surface. The wellbore fluids disclosed herein may perform several different functions during the methods or operations, such as, for example, cooling the bit, removing drilled cuttings from the bottom of the hole, suspending, coating, and/or encapsulating the cuttings, coating walls of the wellbore, and/or weighting the material within the wellbore when circulation is interrupted.

The wellbore fluids including the wellbore fluid additives disclosed herein, when circulated through a wellbore, may form a filter cake on surfaces of the formation through which the wellbore extends (e.g., surfaces of the formation defining the wellbore). In some embodiments, the wellbore fluid additives may be present in the filter cake. In some embodiments, at least some of the wellbore fluid additives are present in the filter cake, and at least other of the wellbore fluid additives are in cracks, pores, fissures, or other openings in the formation.

The wellbore fluid additives disclosed herein may be added to the base fluids on location at a well-site where it is to be used, or may carried out at locations other than the well-site. If the well-site location is selected for carrying out this step, the wellbore fluid additives disclosed herein may be dispersed in the base fluids, and the resulting wellbore fluids may be emplaced, disposed, and/or circulated in the wellbores using techniques known in the art. In one or more embodiments, the components of the wellbore fluids disclosed herein (i.e., the aqueous base fluids, the wellbore fluid additives, and/or the one or more optional wellbore additives) may be added to the wellbores simultaneously or sequentially, depending on the demands of the downhole environments. In some embodiments, the wellbore fluids disclosed herein may be emplaced or provided into the wellbores before or after adding one or more preflush or overflush fluids.

In some embodiments, the methods disclosed herein may prevent or reduce fluid losses in the wellbores whereby the wellbore fluids disclosed herein are circulated in the wellbores. The methods and wellbore fluids disclosed herein may be utilized in a variety of subterranean operations that involve subterranean drilling, drilling-in (without displacement of the fluid for completion operations) and/or fracturing. Examples of suitable subterranean drilling operations include, but are not limited to, water well drilling, oil/gas well drilling, utilities drilling, tunneling, construction/installation of subterranean pipelines and service lines, and the like. In some embodiments, the methods and wellbore fluids disclosed herein may be used to stimulate the fluid production.

In some embodiments, the wellbore may be used for carbon capture, utilization, and storage (CCUS) and/or for recovery and use of geothermal energy. Geothermal energy is a promising source of renewable energy that captures energy from heat generated or stored within the earth. For example, geothermal energy may be used to perform climate control (e.g., heat, cool) for structures (e.g., buildings) and/or to generate electricity (e.g., by heating water to generate steam and drive a turbine with the steam or by using heat pumps). The wellbores described herein may be used to circulate a working fluid that exchanges heat within the earth formation through which the wellbore extends. The working fluid may be circulated to the surface where a surface heat exchanger is used to transfer thermal energy to generate electrical and/or for climate control. After thermal energy is transferred from the working fluid in the surface heat exchanger, the working fluid is circulated back to the earth formation to continue the cycle.

CCUS facilitates the capture, use, and/or storage of carbon (e.g., carbon dioxide), which has a goal of achieving carbon neutrality and/or net zero carbon emissions (NZE). CCUS may facilitate the capture of carbon dioxide from large point sources (e.g., power plants, refineries, cement plants, other industrial processing plants, or other industrial facilities that use fossil fuels, biomass fuels, or other fuels that generate carbon dioxide). The captured carbon dioxide may be converted into valuable products such as, for example, ethanol, sustainable aviation fuel, chemicals, and mineral aggregates. Alternatively, the carbon dioxide may be stored in geologic formations, such as in depleted hydrocarbon reservoirs. The carbon dioxide may be introduced into the earth formation through a wellbore, such as the wellbore described herein. In the earth formation, the carbon dioxide may be dispersed in an aqueous phase and stored as carbon dioxide, in mineral form (e.g., as a carbonate, such as calcium carbonate, magnesium carbonate, iron (II) carbonate), or as another form of carbon.

In one or more embodiments, the fluid formulations and/or compositions disclosed herein may comprise or consist of, or the methods disclosed herein may utilize, one or more components and/or additives selected from: one or more aqueous- or water-base base fluids (hereinafter “the base fluid”); one or more shale inhibitors (hereinafter “the shale inhibitor”); one or more celluloses (hereinafter “the cellulose”); one or more viscosifiers (hereinafter “the viscosifier”); one or more of the wellbore fluid additives disclosed herein; one or more ROP enhancers (hereinafter “the enhancer”); one or more weighting agents (hereinafter “the weighting agent”); one or more clays (hereinafter “the clay”); or a combination thereof.

In some embodiments, the base fluid may be, comprise, or consist of at least one brine, the shale inhibitor may be, comprise, or consist of at least one amine shale inhibitor, and/or the cellulose may be, comprise, or consist of at least one polyanionic cellulose. Further, the viscosifier may be, comprise, or consist of at least one biopolymer viscosifier, at least one xanthan, or a combination thereof, and/or the enhancer may be, comprise, or consist of at least one water-based mud ROP enhancer. Still further, the weighting agent may be, comprise, or consist of at least one barite, and/or the clay may be at least one API evaluation base clay (hereinafter “API clay”).

In at least one embodiment, the base fluid may be at least one sodium chloride brine. Additionally, the cellulose may be, comprise, or consist of POLYPAC UL, the viscosifier may be, comprise, or consist of DUO-VIS, the enhancer may be, comprise, or consist of ULTRAFREE, and/or the weighting agent may be, comprise, or consist of M-I WATE, each available from M-I L.L.C. (Houston, Tex.).

### EXAMPLES

In the following examples, a series of experiments were conducted and illustrate improved fluid loss, wellbore sealing, and/or cuttings integrity performances for the wellbore fluid additives disclosed herein.

### Example 1

Example 1 is direct to a fluid formulation used to measure fluid loss, wherein the composition of the inventive fluid formulation is set forth in TABLE 1.

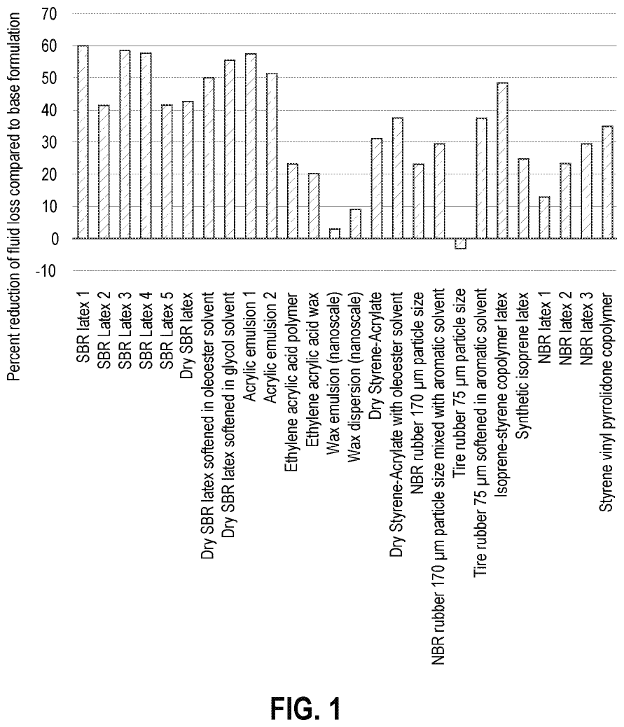

TABLE 1
Example of formulation used to test fluid loss set forth in FIG. 1.

| Additive | Grams per 350 ml barrel | |
|---|---|---|
| 1% NaCl | 288.46 | |
| Amine based shale | 0-30 | vol % |
| inhibitors | | |
| polyanionic cellulose | 1-5 | ppb |
| xanthan | 0-3 | ppb |
| Additive | 0-30 | ppb |
| rate of penetration | 0-3 | vol % |
| enhancer | | |
| barite | 0-400 | ppb |
| Mud Weight, ppg | 8-22 | ppg |

A large variety of inventive additives were tested and experimental testing results are shown in FIG. 1 which is a chart showing fluid loss reduction when testing the inventive additives at 280° F. (about 137.8° C.), wherein the percent reduction is relative to a blank with no inventive additive (e.g., relative to a wellbore fluid not including the inventive additive). Test fluids including the fluid formation of FIG. 1 with the same amount of the wellbore fluid additives shown in FIG. 1 were formulated and the fluid loss of such fluids was measured. The fluid loss of fluids of the different test fluids was tested using a synthetic disk designed to simulate (represent) formation rock, except for the styrene vinyl pyrrolidone, which was tested at 200° F. (about 93.3° C.) on paper. The fluid loss tests were conducted by applying a 500 psig (about 3,447 kPa) pressure differential across the synthetic disk and measuring the amount of the fluid that passes through the synthetic disk (e.g., the pressure of the test fluid was 500 psig higher than the pressure of the fluid that filtered through the synthetic disk). The inventive additives comprise wax dispersions, emulsions of liquid polymers, latexes, solid elastomers, silicone oil emulsions, and nano-scale solids. From the data testing results shown FIG. 1, at least one pattern emerges that elastomeric additives are particularly effective with respect to reducing fluid loss. In other words, it is not sufficient for inventive additive material to be small particle size. Instead, the inventive additive material should have characteristics of soft and rubbery material to be effective with respect to reducing fluid loss. To further highlight the importance of soft and rubbery material versus particle size, a comparison of wax or silicone emulsions with ground rubber material and styrene-acrylate fluid loss polymer for non-aqueous fluids shows that even 170 μm nitrile rubber (hereinafter “NBR”) works more effectively than nano-scale dispersions of waxes, silicones, or other liquid polymers. For example, while not shown in FIG. 1, a silicon emulsion reduced fluid loss by 3%, less than the 170 μm nitrile rubber reduced fluid loss.

Further, FIG. 1 also shows experimental data for LeHigh nitrile rubber (i.e., ground tire rubber comprising NBR) that was and was not soaked in solvent. The ground tire rubber had an average particle size of about 75 μm. LeHigh nitrile rubber provided improvement for fluid loss reduction while ground up tire rubber did not. However, soaking tire rubber in aromatic 200 solvent (an organic solvent containing a mixture of hydrocarbons including aromatic hydrocarbons having C12-C15 carbon numbers; the aromatic 200 may include methylnaphthalenes). which swells and softens the rubber improved the fluid loss result. The fluid loss achieved by nitrile rubber did not improve after soaking with solvent because nitrile rubber resists swelling from solvents. This example provides a method of improving fluid loss by targeted softening of rubber. Another example of reduction of fluid loss by soaking product in oil is dry styrene butadiene rubber soaked in EGMBE. Solvents, such as, for example, EGMBE substantially soften the dry latex and provide the greatest reductions in fluid loss.

### Example 2

Example 2 is directed to a cuttings integrity test. As shown in the experimental test data in TABLE 3, the inventive additives disclosed herein may also improve cuttings integrity which is an additional benefit helping to improve overall performance of WBM. The WBM formulation used for the cuttings integrity testing of Example 3 is set forth in TABLE 2 below.

TABLE 2
WBM formulation used to test improvements of cuttings integrity
by adding the inventive wellbore fluid additives.

| Additive | Grams per 350 ml barrel |
|---|---|
| 1% NaCl | 296.05 |
| Amine shale inhibitor | 10.00 |
| Ultralow-viscosity | 2.00 |
| polyanionic cellulose | |
| Xanthan | 1.25 |
| Additive | variable |
| API Clay | 15.00 |
| barite | 129.9 |
| Vol, mL | 350 |
| Mud Weight, ppg | 11.00 |

In Example 2, a cuttings hardness and dispersion test was performed when 30 grams of cuttings (i.e., Arne clay) was added to a drilling fluid and system that was hot rolled for 16 hours. Cuttings were removed and the weight, moisture content, and bulk hardness of the cuttings were measured. It is pointed out that highest recovery is desired, lowest moisture content is desired, and highest number for bulk hardness is also desired. The experimental data set forth in TABLE 3 shows that adding an inventive wellbore Sealant 1 disclosed herein reduces moisture of cuttings and increases bulk hardness. Other inventive latex-based additives, such as, for example, Sealant 2 and Sealant 3 also increase bulk hardness and provide unexpected benefits to moisture reduction and cuttings recovery. These benefits are in addition to the primary benefit of the inventive wellbore sealants which is prevention or reduction in fluid loss. Accordingly, the chemistries of the wellbore fluid additives disclosed herein are novel and inventive because the wellbore fluid additives unexpectedly contribute positively to both fluid losses and cuttings hardnesses in the WBMs.

TABLE 3
Cuttings Integrity improvements with inventive wellbore fluid additives.

| | Baseline (no | Sealant 1 | Sealant 2 | Sealant 3 |
|---|---|---|---|---|
| | additive) | 10 ppb | 10 ppb | 10 ppb |
| % Moisture after dispersion test | 25.05% | 23.72% | 24.60% | 24.74% |
| % Cuttings retention after | 91% | 92% | 100% | 93% |
| dispersion test | | | | |
| reading at 4 turns | 55 | 90 | 67 | 72 |

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

1. A wellbore fluid, comprising:
an aqueous base fluid;
one or more weighting agents; and
at least one polymer-based fluid loss additive comprising swellable elastomer particulates,
wherein wellbore fluid has a density of at least about 9 ppg and no more than about 24 ppg,
wherein the swellable elastomer particulates comprise recycled rubber material and/or nitrile rubber material, and
wherein the recycled rubber material comprises at least one synthetic rubber copolymer, carbon, at least one curing agent, and at least one fatty acid.

2. The wellbore fluid of claim 1, wherein the swellable elastomer particulates comprise solvent-swelled elastomer particulates.

3. The wellbore fluid of claim 1, wherein the swellable elastomer particulates comprise natural polymer particulates, synthetic polymer particulates, or a combination thereof.

4. (canceled)

5. The wellbore fluid of claim 1, wherein the recycled rubber material is present in the form of grounded powder.

6. (canceled)

7. The wellbore fluid of claim 1, wherein:
the at least one synthetic rubber copolymer comprises styrene and butadiene;
the carbon comprises carbon black;
the at least one curing agent comprises zinc oxide; and
the at least one fatty acid comprises stearic acid.

8. The wellbore fluid of claim 1, wherein the at least one polymer-based fluid loss additive is at least one latex-based fluid loss additive.

9. The wellbore fluid of claim 8, wherein the at least one latex-based fluid loss additive comprises at least one styrene-butadiene latex, at least one acrylic latex, at least one isoprene latex, at least one styrene vinyl pyrrolidone latex, at least one styrene-acrylic polymer, or a combination thereof.

10. A wellbore fluid, comprising:
an aqueous base fluid;
one or more weighting agents; and
at least one polymer-based fluid loss additive comprising swellable elastomer particulates,
wherein wellbore fluid has a density of at least about 9 ppg and no more than about 24 ppg,
wherein the at least one polymer-based fluid loss additive is at least one latex-based fluid loss additive,
wherein the at least one latex-based fluid loss additive comprises at least one styrene-butadiene latex, at least one acrylic latex, at least one isoprene latex, at least one styrene vinyl pyrrolidone latex, at least one styrene-acrylic polymer, or a combination thereof, and
wherein the at least one latex-based fluid loss additive comprises at least one styrene vinyl pyrrolidone latex.

11. The wellbore fluid of claim 1, wherein the density of the wellbore fluid is at least about 7 ppg and no more than about 15 ppg.

12.-20. (canceled)

21. The wellbore fluid of claim 10, wherein the swellable elastomer particulates comprise solvent-swelled elastomer particulates.

22. The wellbore fluid of claim 10, wherein the swellable elastomer particulates comprise natural polymer particulates, synthetic polymer particulates, or a combination thereof.

23. The wellbore fluid of claim 10, wherein the swellable elastomer particulates comprise recycled rubber material and/or nitrile rubber material.

24. The wellbore fluid of claim 23, wherein the recycled rubber material is present in the form of grounded powder.

25. The wellbore fluid of claim 10, wherein the density of the wellbore fluid is at least about 7 ppg and no more than about 15 ppg.
